(19) United States
(12) Patent Application Publication
(10) Pub. No.: US 2026/0093722 A1
(43) Pub. Date: Apr. 2, 2026

(54) INTEGRATED SELF-EVALUATION AND FOLLOW-UP SUGGESTION MECHANISM FOR RAG SYSTEMS

(71) Applicant: DELINEA INC., San Francisco, CA (US)

(72) Inventor: Peter Gerardus JANSEN, Goirle (NL)

(21) Appl. No.: 18/988,671

(22) Filed: Dec. 19, 2024

Related U.S. Application Data
(60) Provisional application No. 63/701,826, filed on Oct. 1, 2024.

(51) Int. Cl. G06F 16/332; G06F 16/3329; G06F 16/383

(52) U.S. Cl. CPC G06F 16/3322; G06F 16/33295; G06F 16/383

(57) ABSTRACT

A system and method for using retrieval-augmented generation (RAG), in a large language model (LLM) having additional content to enhance relevance of LLM generated content. In operation, a user asks a question and the LLM determines whether additional content needs to be retrieved from a data management system to answer the question. If so, the LLM is provided with the user question and said additional content and asked to score its ability to confidently answer the question with the provided content. If the score is below a predefined threshold, the LLM is instructed to generate an alternate response using the retrieved additional content. Additionally, the system generates follow-up suggestions to assist the user in gaining more in-depth knowledge on the subject at hand. If the score is below a predefined threshold for a selected suggestion, the system will record this to assist to fill gaps in available content.

### BACKGROUND OF THE INVENTION

Artificial Intelligence (AI) is a branch of computer science that aims to create systems capable of performing tasks that typically require human intelligence. These tasks include learning, reasoning, problem-solving, perception, language understanding, and interaction. AI systems leverage various techniques such as machine learning, natural language processing, and neural networks to analyze data, recognize patterns, and make decisions.

One of the emerging areas within AI is Retrieval-Augmented Generation (RAG), which combines the strengths of retrieval-based and generation-based models. RAG systems can retrieve relevant information from a large corpus of data and use it to generate coherent and contextually appropriate responses. This approach enhances the quality and relevance of the generated content, making it particularly useful in applications like chatbots, virtual assistants, and automated content creation.

RAG is a technique that grants generative artificial intelligence models information retrieval capabilities. Typically, RAG is utilized in connection with a large language model (LLM) which is a subset of AI models tailored for text-based tasks, while AI models cover a wider spectrum of intelligent behavior across various domains. RAG modifies interactions with a LLM so that the model responds to user queries with reference to a specified set of documents, using this information to augment information drawn from its own training data. This allows LLMs to use domain-specific and/or updated information. Use cases include providing chatbot access to internal company data or relying on information from an authoritative source. Nevertheless, the use of RAG does not completely eliminate the general challenges faced by ILMs, including hallucinations.

In the context of AI generally and LLMs with RAG, hallucinations refer to instances where the AI system generates information that is not grounded in the retrieved data or factual reality. These hallucinations can manifest as fabricated details, incorrect facts, or entirely fictional content that the model presents as true.

RAG systems are designed to enhance the quality of generated responses by retrieving relevant information from sources outside the training of the LLM and using it to inform the generation process. However, despite this retrieval step, the generation component can still produce hallucinations due to a number of factors including:
1. Model Overconfidence: The generative model, with or without RAG, may produce confident-sounding but incorrect responses, especially when it encounters ambiguous or incomplete information.
2. Data Gaps: If the retrieved data, with or without RAG, does not fully cover the query or is itself incomplete or inaccurate, the generative model, even with RAG, may fill in the gaps with plausible but incorrect information.
3. Training Biases: The model may have learned biases from the training data, leading it to generate responses that reflect these biases rather than objective facts.
4. Complex Queries: For complex or nuanced queries, the model may struggle to accurately synthesize information from multiple sources, leading to errors or fabrications.

As a result of these factors, the LLM may try to “make the most of it” and in that process sometimes it tends to fill gaps in content the way it thinks makes sense. This works without a problem at times, but sometimes it does not. This can happen notwithstanding that the LLM prompt explicitly instructs the LLM to only use facts/data and not fabricate anything.

Hallucinations pose a significant challenge for RAG systems, particularly in applications where accuracy and reliability are critical, such as in healthcare, legal advice, and customer support. Addressing this issue requires ongoing research and development to improve the mechanisms for information retrieval, response generation, and self-evaluation.

There are several prior art ways to build checks for LLM hallucinations. One is to await the full answer of the LLM and then introduce a step where the LLM is provided with the user question, the content provided and the answer that was generated, and then ask the LLM if the answer is correct. This is a common method of checking the LLM output and preventing hallucinations or at least reducing them. The downside of this method is it is necessary to wait for the entire answer (which can take a while) before this check can be performed, meaning that (parts of) the answer cannot be shown while the answer is being generated, because the answer may turn out to be scored as wrong (or not correct enough), in which case the model has to be requested to provide alternate output.

RAG can be implemented in many ways. Basically, it involves adding additional content to the LLM conversation so that the LLM has access to data it would otherwise not have access to because it is not part of its pre-trained knowledge.

For example, when using the public OpenAI chat function (chat.openai.com), there is an option to upload a file and ask questions about it. Technically, this is a RAG system because it allows the LLM to answer questions (about the file) that it would normally not be able to (therefore ‘retrieval augmented’). There is an Azure OpenAI Playground where one can experiment with prompts and questions etc., which includes the option to add your own data and/or files and ask questions about them. There are many code-based examples in GitHub that provide basic solutions for doing RAG, for example: https://github.com/Azure/GPT-RAG or https://github.com/microsoft/promptflow-rag-project-template.

FIG. 1 illustrates a prior art RAG system in which:

User asks a question 11 in some input format (text, speech, etc). The LLM determines if additional content 12 needs to be retrieved. This is a typical part of a RAG system. If no additional content needs to be retrieved, i.e., the question can be answered from knowledge that the LLM was pre-trained on, the answer is generated 13 by the LLM and is presented 14 to the user in some output format (text, speech, etc.). It should be noted that an LLM with RAG differs from an LLM without RAG in that without RAG, the LLM will do its best to respond to the prompt, but if it is unable to, e.g., the prompt requires information which did not exist when the model was trained, it will so indicate in its response. However, with RAG, the LLM will attempt to respond by accessing external sources.

Specifically, if additional content needs to be retrieved 15, this is done from a data management system (database, search index, Representational State Transfer (REST), etc.). The answer is generated 16 by the LLM using the additional content that was retrieved and pre-trained knowledge. This is where hallucinations can occur. The answer, which may not be correct, is presented 17 to the user in some output format (text, speech, etc.).

It should be noted that steps 12, 13 and 16 use a LLM.

### SUMMARY OF THE INVENTION

A novel self-evaluation mechanism is disclosed for LLMs based on RAG. This mechanism aims to improve the accuracy and reliability of the generated responses by continuously assessing and refining the retrieval and generation processes. By incorporating self-evaluation, the RAG system can prevent hallucinations, correct errors, and optimize its performance, leading to more effective and trustworthy LLM applications. By enhancing these components, RAG systems can reduce the occurrence of hallucinations and provide more trustworthy and accurate responses.

In an embodiment, after the user asks the question, relevant content is retrieved. A new step is then introduced that provides the LLM with the user question and the retrieved content and asks if it can confidently answer the question. The advantage is that it is not necessary to wait for the answer to be generated (which can take considerable time). Only one additional request is made to the LLM to check the content. This request is fast, because the request is only for a single token as output, e.g., “true” or “false”; typically with LLMs, the lengthier the output, the longer the request takes. The output is not only the “true”/“false” indication of its ability to confidently answer the question, but also a probability score, indicating how sure the model is in this output. Based on the output of this request, the system either lets the LLM answer the question normally (in case the self-evaluation step indicates that the question can confidently be answered from the given content, for example if the probability score is above 0.95 or 95%) or (in case the self-evaluation fails) the system prompts the LLM to answer with several alternate answers based on the given content.

Subsequently, after the answer has been presented to the user, the LLM is prompted to generate multiple suggestions for possible follow-up questions, based on the users conversation so far (including questions, retrieved content and answers).

Finally, when one of these suggested follow-up questions is used and then fails the self-evaluation step, this is recorded in a feedback system because it indicates a gap in the content that is available to the RAG system, while the relevance of the question is made apparent by the user's decision to use it.

### BRIEF DESCRIPTION OF THE DRAWINGS

FIG. 1 is a flow diagram for a prior art RAG system.

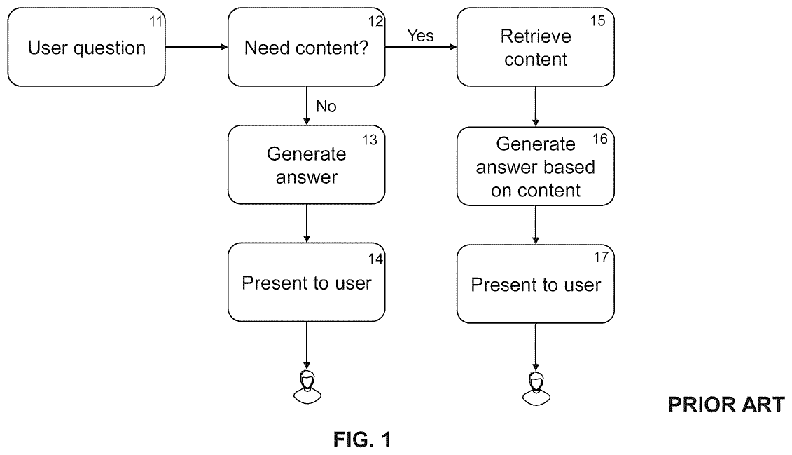

FIG. 2 is a flow diagram for a first embodiment of a RAG system which on failure of self-evaluation generates alternate answers according to the invention.

FIG. 3 is a flow diagram for a second embodiment of a RAG system which generates suggested follow-up questions according to the invention.

FIG. 4 is a flow diagram for a third embodiment of a RAG system which performs self-evaluation on suggested follow-up questions according to the invention.

FIG. 5 is a block diagram showing the how a RAG system and user computer are connected.

### DETAILED DESCRIPTION OF THE INVENTION

To enhance the reliability and accuracy of Retrieval-Augmented Generation (RAG) systems, a novel self-evaluation mechanism is introduced.

In an embodiment, a RAG system is created using Azure OpenAI SDK (client) and defining so called ‘tools’ in code that tell Azure OpenAI that there are additional sources that it can get content from if needed. Azure OpenAI then calls back to the system to retrieve that additional content.

The self-evaluation mechanism adds an extra step after the appropriate content is retrieved. The original user question and the retrieved content are used to ask the LLM whether it can confidently answer the user question using the provided content. The LLM is instructed to respond only with “true” or “false.”. It then uses the probabilities output that LLMs can typically be configured to provide, to calculate a score that indicates the level of confidence for the LLM to be able to answer the user question from the given content. If this score is above a predefined threshold (e.g., 0.95 or 95%), the LLM is allowed to continue answering the question using the provided content. However, if this score falls below that threshold, the LLM is not permitted to answer the original question directly. Instead, it is prompted to inform the user that the content does not provide a definite answer and to list possible alternative answers or relevant information based on the provided content. This response is then presented to the user, ensuring that the system only provides confident and reliable information when possible while offering alternative insights when certainty is lacking.

It should be noted that no specific training of the LLM is involved to enable the LLM to score its confidence level. Rather, the pre-trained knowledge of the LLM is used to ascertain whether it can confidently answer the question correctly from the content provided. As an example, the LLM model could be is prompted with:
“Considering the information provided in the content and the user question above: Before even answering the question, consider whether you have sufficient information in the content to answer the question fully. Your output should just be the boolean true or false, based on whether you have sufficient information in the content to answer the question.”

The ‘content’ in this case is the content that is retrieved from a content database that is relevant to the user question. This augments the LLM's pre-trained knowledge (which can be outdated) with pertinent specific and up-to-date knowledge. This content is used by the LLM to generate the answer and then it is also used by the self-evaluation step to determine if the LLM is confident enough that the provided content can be used to give a valid answer. Without this step, LLM's can be over-confident or ‘hallucinate’ and provide answers which are not always fully grounded in the provided (or pre-trained) data.

The specific and up to date knowledge would typically be based on a cloud subscription service and is updated by specific components which would depend on the type of cloud subscription service available to the user and would be very specific to the environment in which it is implemented. It is therefore not detailed any further since persons skilled in the art of the specific environment would know what is needed to maintain the external content that can be used by a RAG system.

LLMs typically function based on a ‘next token probability’ mechanism, where the model generates output text by calculating probabilities for all possible next tokens in its vocabulary. These probabilities refer to the likelihood of a specific token (word or subword) appearing next in a sequence, given the preceding context. Typically, an LLM can be configured to include these per-token probabilities in its output along with the output tokens themselves. For a typical answer consisting of one or more sentences, these probabilities per output token do not add much value. In this instance, i.e., asking the LLM to determine its ability to answer the user question correctly from the provided content and to answer only with “true” or “false” (where “true” means “I can answer confidently” and “false” means “I cannot answer confidently”). However, there is not a lot of room for nuance in a true/false answer, “true” could mean “just barely true” or it could mean “definitely true”. The per-token probability on the output token (output token being “true” or “false”) indicates how certain the LLM is that this output token is correct in this sequence: if the output is “true” but the probability on that token is only 0.6 (or 60%) it is actually not very sure. The probability provided in the output of the model, in combination with the output (“true” or “false”) therefore represents a nuanced level of confidence that the model can accurately answer the question with the given content. This score, which typically falls in the range of 0 to 1 (or 0 to 100%), in combination with the output (“true” or “false”), is important because the confidence level is not solely a true or false outcome, the score or probability adds a way of grading the confidence level, providing the system with a means to balance confidence in answering questions factually, but still allowing for generational capabilities.

When this confidence level is above a certain threshold, the system continues to let the LLM answer the question in a regular way. However, when the confidence score falls below a certain threshold (such as 0.95 or 95% in one embodiment), the LLM is instructed to take the user's question combined with the provided content and come up with several alternate answers or relevant information that can be provided with this retrieved content. These alternate answers/information may not answer the original user question completely, but they might provide additional context for the user to try and understand why the LLM could not answer the original question. These alternate answers will be given in a format like: “The documentation does not provide specific information on xxxxxxxxxxx. However, here are some related topics that might be of interest: yyyyyyyy, zzzzzzzzzz, etc”. The important difference is that the alternative answers are not presented as definitive answers, rather they are presented as topics that may be relevant.

An alternative way of doing a self-evaluation is first letting the LLM answer the question and then evaluating the answer in combination with the content. However, first generating the full answer takes much more time than performing the evaluation on just the question and retrieved content because the time an LLM needs to complete its answer depends in large part on the size of the output. Also, doing the evaluation on the full answer means that the system cannot start streaming parts of the answer to the user until the full answer has been generated and the evaluation has taken place. This would result in a system with a much worse perceived performance.

In an embodiment, the evaluation is performed after the relevant content has been retrieved. The advantage of doing this as opposed to doing evaluation of the full answer is that the evaluation on the content can be done much sooner in the process and therefore has little impact on the overall user experience. When doing a self-evaluation on the entire answer, the system first has to wait for the LLM to generate the entire response. This can take a considerable amount of time (anywhere from 10-60 seconds). The request to the LLM to consider the user question and retrieved content and respond only with “true” or “false” indicating if the LLM is confident that it can accurately answer the question is fast, because the amount of time it takes an LLM to answer typically depends largely on the number of output tokens rather than on the number of input tokens.

Because the evaluation is performed after the content is retrieved, if there is no content to retrieve, there is no evaluation to be performed. The rationale for this is to make sure that the answers that are based on the content added to the LLM are correct. This means that if the answer is not based on the added content, but based on pre-trained, pre-existing knowledge that is part of the LLM, the LLM it can still hallucinate. However, this is not the problem being addressed by the invention.

To enhance user engagement and provide more comprehensive assistance, a mechanism is provided that generates suggestions for follow-up questions in a chatbot or Retrieval-Augmented Generation (RAG) system. This mechanism leverages the conversation history, including any content retrieved by the RAG system, to create contextually relevant suggestions for follow-up questions. The LLM is prompted with a specific instruction to analyze the ongoing conversation and the retrieved content, and then generate a list of potential follow-up questions that could further clarify, expand, or delve deeper into the topic at hand. These suggested questions are designed to guide the user towards more detailed and informative interactions, ensuring that the chatbot can address the user's needs more effectively. By dynamically generating suggested follow-up questions based on the conversation context, this mechanism helps maintain a natural and engaging dialogue, ultimately improving the user experience and the utility of the RAG system.

To further enhance the reliability of RAG systems and the ability to detect missing or incorrect content, an integrated mechanism will now be described that combines self-evaluation and suggested follow-up questions. This process begins with the LLM generating contextually relevant suggested follow-up questions based on the conversation history and any retrieved content. When a user clicks or otherwise selects one of these suggested questions, the AI model attempts to generate an answer as it would also do when the user submitted a question. However, before presenting the response, the self-evaluation mechanism is triggered (as would also happen when the user submitted a question). As noted above, this mechanism uses the question (in this case the suggestion selected by the user) and the retrieved content to ask the LLM whether it can confidently answer the question, responding with “true” or “false” and providing a probability score representing the level of confidence whether the LLM can accurately answer the question.

If the probability score falls below the predefined threshold (e.g., 0.95 or 95%), indicating that the LLM cannot confidently generate an answer, the system tells the user that there is not enough information available and provides alternative answers from the available content. At the same time, because the LLM knows this question came from a suggestion, the system automatically creates an item in a feedback system. This feedback item flags the suggestion as a question that was interesting enough for the user to select, but that the RAG system could not confidently answer. This feedback is crucial for continuous improvement, allowing content managers to identify gaps in the system's knowledge base. By integrating these mechanisms, the RAG system not only enhances user interaction through relevant follow-up questions but also ensures the reliability of its responses and facilitates ongoing system and content improvement through user feedback.

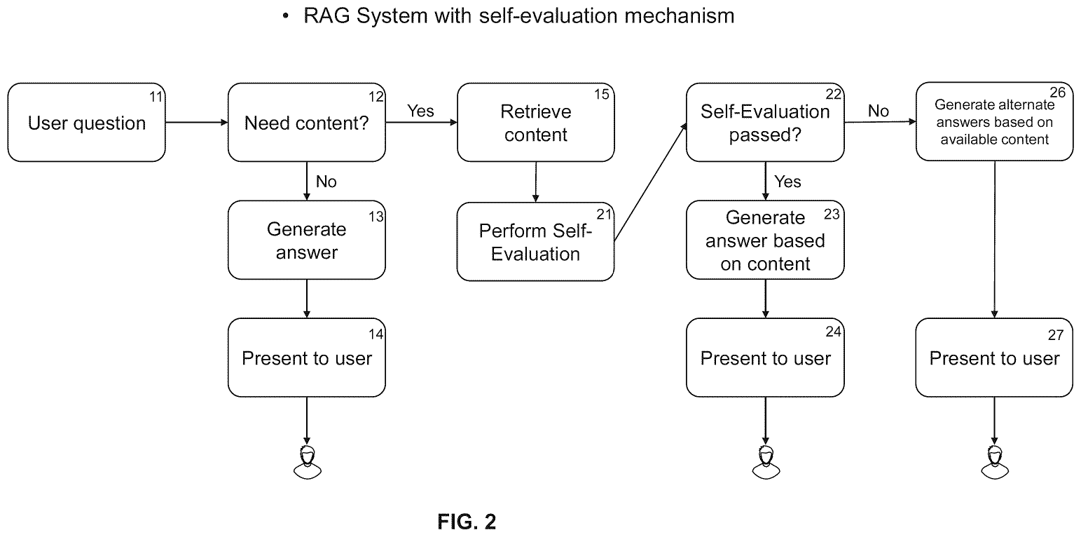

FIG. 2 illustrates a RAG system with a self-evaluation mechanism. As shown in FIG. 2, a user asks a question 11 in some input format (text, speech, etc) as in the prior art. LLM determines if additional content needs 12 to be retrieved as in the prior art RAG system. If no additional content needs to be retrieved, i.e. the question can be answered from knowledge that LLM was pre-trained on, the answer is generated 13 by the LLM as in the prior art. The answer is presented 14 to the user in some output format (text, speech, etc) as in the prior art. Although it is possible for the answer to include hallucinations, they would be based on the training of the LLM. Such hallucinations are not addressed by the invention which is focused on hallucinations resulting from sources external to the LLM training. If additional content needs to be retrieved 15, this is done from a data management system (database, search index, Representational State Transfer (REST) API, etc.) as in the prior art.

However, rather than presenting the answer to the user as in the prior art, self-evaluation is performed 21 by providing the LLM with the user question and the retrieved content and asking it to score its ability to confidently answer the question. The self-evaluation determines if the answer can be confidently generated from the question and retrieved content using the mechanism mentioned before.

If the self-evaluation passed, the LLM is allowed to answer the question by generating an answer 23 from the provided content which is presented 24 to the user in some output format (text, speech, etc.).

If the self-evaluation did not pass, the LLM is instructed that the provided content does not contain the full and/or correct answer and to generate 26 a response with several alternate answers or relevant information from the content. The response is presented 27 to the user in some output format (text, speech, etc.).

As noted above, without the self-evaluation, the LLM can hallucinate, basically being over-confident, filling in gaps and coming up with answers that are not necessarily grounded in the content provided. The self-evaluation step prevents this by introducing a step that forces the LLM to score its ability to provide a correct answer from the given content.

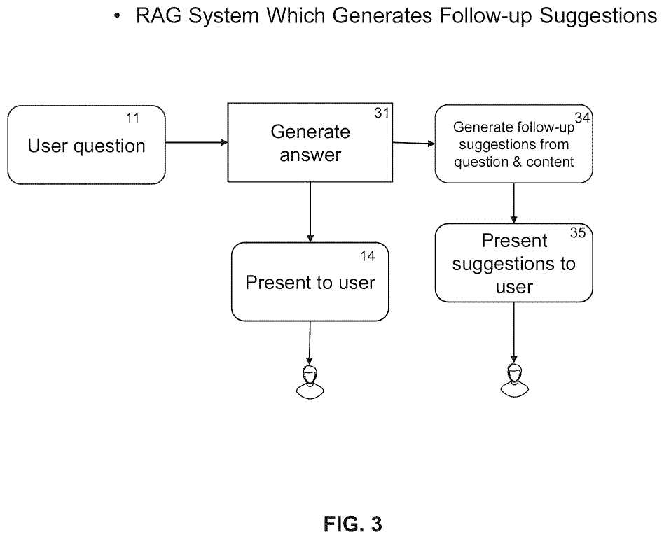

Referring now to FIG. 3, an embodiment will be described where rather than alternate answers are provided as in FIG. 2, suggested follow-up questions are generated from the user question and retrieved content.

The user asks a question 11 in some input format (text, speech, etc.) as in the prior art. The AI model generates an answer 31 which represents the combined steps 12-13, 15, 21-23 and 26 in FIG. 2. If no additional content is needed to answer the question, the answer 14 is presented to the user in some output format (text, speech, etc.) as in FIG. 2. Otherwise, the LLM is then instructed to generate 34 suggested follow-up questions based on the user question, retrieved content and the generated answer. These suggestions are presented 35 to the user in some output format (text, speech, etc.). That is, unlike the FIG. 2 embodiment, in FIG. 3, rather than generating alternative answers 26 as in FIG. 2, it generates suggested follow-up questions 34 which are then presented 35 to the user.

FIGS. 2 and 3 represent two similar but separate mechanisms. FIG. 2 deals with evaluating the user question and retrieved content and asking the LLM if it can confidently answer the question with that content. If it can, the LLM answers normally. If it cannot, based on the score which is determined as discussed above, the LLM generates alternate answers based on the content, as in “The documentation does not provide a definite answer to this question, but maybe one of the following pieces of information will help: x, y, z” where the “x, y, z” are alternate answers.

In this manner, if the self-evaluation fails, the answer is something like “I'm not sure, but here are some related topics that may be of interest: a, b or c”, rather than presenting an answer which may be inaccurate.

Parallel to this, as shown in FIG. 3, regardless of the outcome of the self-evaluation, the LLM is asked to generate suggested follow-up questions which it should be noted are not the same as the alternate answers. The alternate answers are generated when self-evaluation fails and are meant as an alternative to the LLM trying to generate a high-confidence answer when it cannot and it is likely to hallucinate.

Regardless of the outcome of the self-evaluation, the LLM is asked to generate, for example, the three suggested follow-up questions. That is, the LLM is instructed to look at the entire user conversation (all previous questions, content and answers) and come up with follow-up questions that make sense in this context. The user can then, for example, select one of the suggested follow-up questions and prompt the LLM with the selected question.

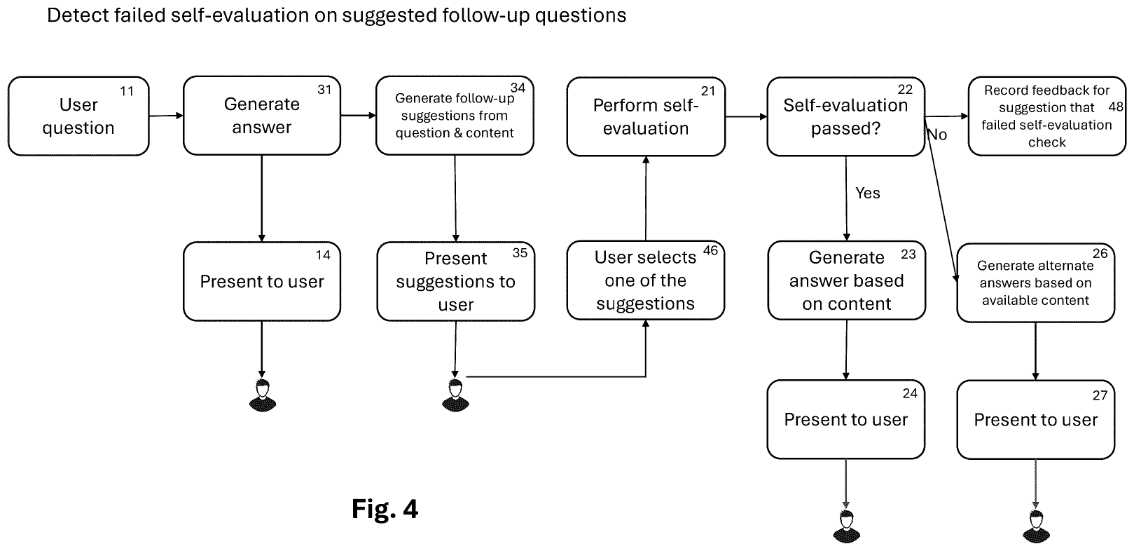

FIG. 4 is directed to another embodiment wherein after a user question has been answered and suggested follow-up questions have been generated as in FIG. 3, the user selects one of the suggestions which is processed as in FIG. 2 but if it fails the self-evaluation step, the selected suggestion is also recorded for feedback purposes. This feedback item flags the suggestion as a question that was interesting enough for the user to select, but that the RAG system could not confidently answer.

The user asks a question 11 in some input format (text, speech, etc.) as in the prior art.

An answer is generated 31 where block 31 represents the processing by blocks 12-13, 15, 21-23 and 26 shown in FIG. 2. That is, it performs self-evaluation 21 (as in FIG. 2). Subsequently it generates suggested follow-up questions 34 as in FIG. 3. These suggestions are presented 35 to the user in some output format (text, speech, etc.) as in FIG. 3. The user selects 46 one of these suggestions as a follow-up question.

The system processes this question as any other question, with the exception that it knows that this was a question selected from the list of suggestions. As part of this processing, it performs a self-evaluation 21 as in FIG. 2 on the question and retrieved content, resulting in a confidence score. The confidence score generated by the self-evaluation is compared 22 to a predefined threshold to determine if the self-evaluation passed. If the self-evaluation fails the system generates alternate answers based on available content 26 which are presented 27 to the user as in FIG. 2 and a feedback item 48 is automatically stored in a system to indicate that this suggested follow-up question did not result in a valid and/or confident answer and that this may require additional and/or changed content. If the self-evaluation 22 passes, an answer is generated based on content 23 and presented 24 to the user as in FIG. 2.

Thus, FIG. 4 combines the two mechanisms: when a “suggested follow-up question” is selected by the user, but it subsequently fails the self-evaluation, which is performed on all questions, instructs the LLM to generate alternate answers as in FIG. 2 and additionally, this occurrence is also recorded in a feedback system, because a suggested follow-up question that could not be answered confidently is something which may require further action such as to check if the RAG content is lacking or unclear, etc.

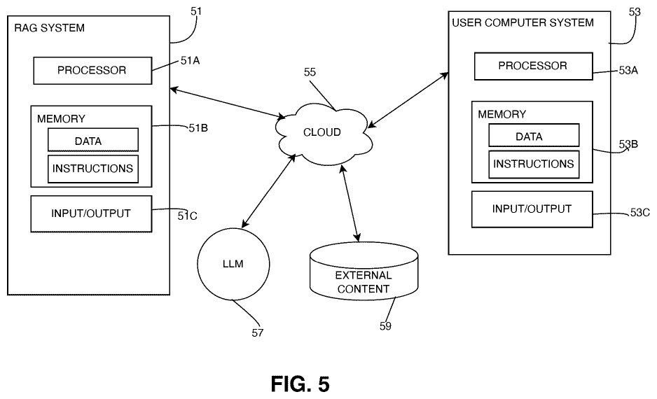

FIG. 5 is a block diagram showing how a RAG system, its LLM, external content, and user computer system connect to each other.

RAG system 51 is any type of computing device with one or more processors 51a, memory 51b for data and instructions, an input/output subsystem 51c. Also shown is LLM 57 which can be integrated as part of the RAG system or, as shown in FIG. 5, a separate element accessible via a network or cloud connection as is well known in the art. The user computer system 53 is also any type of computing device and includes one or more processors 53a, a memory 53b for data and instructions and an input/output subsystem 53c. The processors, memory and input/output subsystems of the RAG system and user computer system and how they operate are all components well known in the art and do not need further explanation for a proper understanding of the invention. The RAG system and user computer system could be directly connected but typically would be connected via a network such as a cloud 55 connection as is well known in the art. Also connected to the cloud 55 is by RAG system 51 and external content 59 which is the source of content which is the retrieved content 15 shown in FIG. 2. Again, the particulars of these various elements and their interconnections are well known and need not be further detailed herein.

The flow and block diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram.

Moreover, not all acts illustrated in a methodology may be required for a novel implementation.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

I claim:

1. A method for using retrieval-augmented generation (RAG), in a large language model (LLM) having additional content from a data management system to enhance quality and relevance of LLM generated content, wherein a user asks a question and the LLM determines additional content is needed to be retrieved from a data management system to answer the question, wherein the method comprises:
providing the LLM with the user question and retrieved additional content;
asking the LLM to score the LLM's ability to answer the question using the provided content, wherein said scoring uses the pre-trained knowledge of the LLM and the retrieved content;
if the score is below a predefined threshold, instructing the LLM to generate an alternate response using said retrieved additional content;
presenting the alternate response to the user.

2. The method defined by claim 1 further comprising generating at least two alternate responses from the retrieved additional content, wherein said alternate response is presented to the user as possibly correct answers.

3. The method defined by claim 1 further comprising generating suggested follow-up questions from the retrieved additional content, wherein said follow-up questions are presented to the user.

4. The method defined by claim 3 further comprising:
said user selecting a suggestion from said suggested follow-up questions, performing a self-evaluation using said selected suggestion and the retrieved additional content and, if the self-evaluation fails, recording feedback indicating that the selected suggestion could not be confidently answered by the LLM, and using said recording to identify gaps in the RAG system's content.

5. The method defined by claim 1 further comprising augmenting the pre-trained knowledge with pertinent specific and up-to-date knowledge based on said retrieved additional content.

6. A system for performing retrieval-augmented generation (RAG), in large language model (LLM) having pre-trained knowledge and additional content for being retrieved from a data management system, said pre-trained knowledge and additional content forming said RAG systems knowledge base said system comprising:
a RAG system having at least one processor, a memory for storing data and instructions for execution by the at least one processor, an input/output subsystem and the LLM;
a large language model operatively coupled to the RAG system;
an external content having a data management system for storing said additional content operatively coupled to the RAG system;
said RAG system for being operatively coupled to a user computer system, said user computer system for providing a question to the LLM which generates content in response to the question and determines whether additional content needs to be retrieved from a data management system to provide a correct answer in response to the question,
wherein the AI model is provided with the user question and the AI generated content; and
the RAG system asks the AI model to score its ability to have confidently answered the question, wherein said scoring uses the pre-trained knowledge of the LLM;
if the score is below a predefined threshold, instructing the AI model to generate an alternate response using said retrieved additional content which alternate response is presented.

7. The system defined by claim 6 wherein the LLM generates a response with at least two alternate answers from the retrieved addition content, wherein said at least two alternate answers are presented to the user as possibly correct answers.

8. The system defined by claim 6 wherein suggested follow-up questions are generated from the retrieved additional content, wherein said follow-up questions are presented to the user as user-selectable suggestions.

9. The system defined by claim 8 wherein after said user selects a suggestion from said follow-up suggestions, a self-evaluation is performed using said selected suggestion and the retrieved additional content and, if the self-evaluation fails, recording feedback to indicate that the selected suggestion could not be confidently answered by the LLM, and using said recording to identify gaps in the RAG system's content.

10. The system defined by claim 6 wherein the pre-trained knowledge is augmented with pertinent specific and up-to-date knowledge based on said retrieved additional content.
